(19) United States
(12) Patent Application Publication
(10) Pub. No.: US 2026/0318749 A1
(43) Pub. Date: Oct. 15, 2026

(54) TEMPERATURE SENSOR ARRANGEMENT WITH SUPPORT STRUCTURE

(71) Applicant: WIKA Alexander Wiegand SE & Co. KG, Klingenberg/Main (DE)

(72) Inventors: Jens KRESSBACH, Frankfurt am Main (DE); Ulrich STAAB, Biebergemuend (DE); Michael TIER, Pearland, TX (US)

(73) Assignee: WIKA Alexander Wiegand SE & Co. KG, Klingenberg/Main (DE)

(21) Appl. No.: 19/645,578

(22) Filed: Apr. 13, 2026

Related U.S. Application Data
(60) Provisional application No. 63/788,341, filed on Apr. 14, 2025.

(51) Int. Cl. G01K 1/14; G01K 7/02; G01K 7/18

(52) U.S. Cl. CPC G01K 1/14; G01K 7/02; G01K 7/18

(57) ABSTRACT

A temperature sensor device comprising a first temperature sensor with at least one temperature-sensitive sensor element and a connector with an input side and a process side opposite the input side. A first through channel extends from the input side to the process side. The first temperature sensor is arranged to pass through the first through channel and is welded or soldered into the first through channel, at least at the process side, either directly or indirectly. A support structure is provided, which is directly or indirectly mechanically rigidly connected or connectable to the connector and has a first support which laterally grips, encloses, or surrounds the first temperature sensor at least in sections at a first distance from the connector.

This nonprovisional application claims priority to U.S. Provisional Application No. 63/788,341, which was filed on Apr. 14, 2025, and which is herein incorporated by reference.

### BACKGROUND OF THE INVENTION

### Field of the Invention

The present invention relates to the technical field of temperature measurement technology, in particular temperature sensor devices for temperature measurement in industrial process plants, for flowing process media or in reactors.

Description of the Background Art Temperature sensor devices are widely used in a wide range of industrial applications where the temperature of a liquid, gaseous, granular or even solid medium is to be measured or monitored. In the following, this variety of applications is summarized by the terms process chamber and process piping. The term “process chamber” may refer to containers or systems in which a medium is stored, stocked or processed. In particular, the term “process chamber” can mean blast furnaces and any kind of pressure vessels and reactors. “Process piping”, on the other hand, refers to those plants and structures in which a medium is advanced, pumped or transported.

Temperature sensor devices typically comprise at least one temperature sensor as well as a one-piece or multi-part connector by means of which the temperature sensor or temperature sensors are mechanically connected to a process connection at a respective so-called measuring point on a process chamber or process piping. The connector serves in particular to seal the process connection in a media-tight manner so that the medium cannot escape from the process chamber or the process piping through the process connection. A well-known problem with such devices is that the temperature sensors are subjected to mechanical stresses, which can lead to damage and leaks.

The mechanical stresses to which the temperature sensors are subjected can result from various factors. In the case of temperature sensors that have a thermowell, these stresses are often caused by the thermowell protruding into a flowing medium, especially in a process piping. The flow of the medium can lead to vibrations and mechanical stresses acting on welded or soldered connections between the thermowell of the temperature sensor and the connector. In the case of temperature sensors that are designed as mineral-insulated sheathed cables and are inserted into a process chamber (e.g., a reactor) without an additional thermowell, additional mechanical stresses can occur even without the flow of the medium in the process chamber if the sheathed cables are guided to certain positions within the process chamber and bent in the process. These mechanical bending stresses can compromise the integrity of the welded or soldered connections and ultimately lead to leaks.

### SUMMARY OF THE INVENTION

It is therefore an object of the invention to provide a temperature sensor device which has improved mechanical stability and overcomes the mentioned problems of mechanical stresses and the resulting leaks.

The temperature sensor device according to an example of the invention can comprise at least one first temperature sensor with at least one temperature-sensitive sensor element as well as a connector with an input side and a process side opposite the input side.

In the context of this invention, the indication that the temperature sensor device or one of its parts or one of its functional units has “at least one” entity of a particular functional unit (e.g., “at least one temperature-sensitive sensing element”, “at least one other temperature sensor”) means that the temperature sensor device or the respective part or functional unit may also comprise several entities of that particular functional unit, but it doesn't have to. “At least one other temperature sensor” includes, for example, two or more other temperature sensors, but also only one other temperature sensor.

If, after the introduction of “at least one” entity of a given functional unit, subsequent sections refer to “each” entity of that functional unit, or even “all” entities of that functional unit (e.g., “each additional temperature sensor” or “all other temperature sensors”), then the totality of all entities, if any, (at least one, but possibly also two or more) of the respective functional unit are meant and these wordings do not introduce any new functional units. These wordings are used in the following in particular if the temperature sensor device has several entities of a particular functional unit and a certain example is to apply equally to each of these entities.

The first temperature sensor may generally have an elongated shape, with a distal end and a proximal end. A lateral extension of the temperature sensor is smaller, for example at least an order of magnitude less than its longitudinal extension. In the vicinity of the distal end or, for example, at the distal end, at least one sensor element is arranged. In examples, further sensor elements can be provided at intervals along the longitudinal extent of the temperature sensor, so that such a temperature sensor can be used to measure a temperature at several points along its elongated extension at the same time.

Each temperature-sensitive sensor element can be designed, for example, as a thermocouple or as a resistance thermometer (for example as a platinum resistor). As an example, the first temperature sensor can comprise several sensor elements of one type or a combination of different types of sensor elements.

The connector is designed to be connected directly or indirectly to a process connection of a process container or a process piping at a measuring point. In this case, the process connection is tightly sealed, directly or indirectly, by the connector in a media-tight manner, and the connector is aligned so that the process side faces the process connection and the inside of the process chamber or process piping, while the input side is aligned accordingly away from the process connection and thus faces the environment surrounding the process chamber or the process piping.

The connector has a first through channel, which extends from the input side to the process side. The first temperature sensor is arranged to pass through the first through channel, such that the distal end of the first temperature sensor enters the process chamber or process piping when the connector is connected to a process connection. The first temperature sensor is welded or soldered directly or indirectly into the first through channel, at least on the process side. This tightly seals the first through channel with the temperature sensor and the welding or soldered connection in a media-tight manner. Connected to a process chamber or process piping, the connector thus acts as a barrier that prevents a process medium located in the process chamber or conveyed in the process piping from escaping.

Furthermore, the temperature sensor device can comprise a support structure which is directly or indirectly mechanically rigidly connected or connectable to the connector. The support structure has a first support that grips, encloses or surrounds the first temperature sensor laterally at least in sections at a first distance from the connector.

In the context of the present invention, “direct” means that the respective parts or functional units or their entities directly enter into the said interaction or linkages with each other, whereas “indirect” means that the said interaction or linkage only comes about by means of or is mediated by other parts, functional units or their entities.

For example, one of the temperature sensors is welded or soldered into the through channel directly on the process side if the welded or soldered connection is made directly between a body of the temperature sensor and an edge of the through channel. If, on the other hand, the welded or soldered connection is not made directly, but for example by using a sleeve that is pulled over the temperature sensor, wherein a first welded or soldered connection is provided, for example, between the edge of the through channel and an outer surface sleeve and a further welding or soldering connection between an edge of the sleeve and the temperature sensor, this corresponds to indirect welding or soldering.

Furthermore, “connected” in the context of the present invention means that the respective parts, functional units or their entities are attached to each other, wherein the respective connection is designed to be non-destructive or damage-free. Such a connection can be achieved, for example, by welding or soldering the aforementioned parts, functional units or their entities to each other, making them from a single piece or producing them integrally as a molded part, for example by casting or additive manufacturing. If, on the other hand, it is provided that the said parts, functional units or their entities are to be attached to each other in a way that is detachable without destruction or damage, this is referred to as “connectable” in the context of the present invention. Such connectability is achieved, for example, by the fact that the parts mentioned above have precautions that enable the parts to be screwed, snapped or clamped to each other or with each other.

The fact that the first support grips, encloses or surrounds the first temperature sensor “laterally at least in sections” means, in the context of this invention, that the first temperature sensor is limited laterally along at least one segment of its circumference by the first support in its deflection capability in the corresponding direction.

In exemplary embodiments, this limitation is fully circumferential. In other exemplary embodiments, however, the limitation may also be interrupted along one or more circumferential segments, wherein a width of those circumferential segments may be less than a diameter of the first temperature sensor, so that the first temperature sensor cannot break out of the first support. In these exemplary embodiments, a limitation of the deflection capability of the first temperature sensor in any lateral direction can be effectively achieved.

For the purpose of a corresponding limitation, for example, it can be provided that the first temperature sensor and the first support touch each other permanently, i.e., that they each rest against each other, wherein in particular there may be a positive fit or force connection. In particular, it may be provided that the first temperature sensor is clamped in the first support. This allows the deflection capability of the first temperature sensor to be restricted particularly effectively, and the support structure stabilizes the first temperature sensor in a beneficial way.

In another possible example, in a first state in which the first temperature sensor is aligned straight and there are no external forces acting on it laterally, a defined distance or a defined clearance between the first temperature sensor and the first support can be provided. This makes it much easier to install the temperature sensor device, while the deflection limit of the first temperature sensor can still be adequately achieved.

The support structure can effectively achieve that mechanical stresses in the area of the welded or soldered connection between the first temperature sensor and the connector, which can be caused by lateral forces acting on the first temperature sensor or by bending the temperature sensor, are drastically reduced. This prevents damage to these points and any resulting leaks in the connector. The first through channel remains reliably sealed by welding or soldering the first temperature sensor. As a result, the temperature sensor device is particularly reliable and has a significantly reduced risk of failure.

For example, the first distance can be at least three times the diameter of the first temperature sensor, for example, at least four times the diameter. By means of an appropriate design, the effects and advantages of the support structure mentioned above can be achieved particularly effectively, while at the same time a compact design can be maintained.

The first temperature sensor can comprise a thermowell and a measuring insert located in a borehole or in a pipe channel of the thermowell. The measuring insert includes at least one temperature-sensitive sensor element.

Thermowells, as mentioned earlier, are often used when the temperature in flowing media is to be measured. Due to the often solid body of the thermowell, the measuring insert can be reliably protected from flow-related mechanical, but also from chemical and other stresses.

Nevertheless, in certain situations or after prolonged periods of use, damage to the connection between the thermowell and the connector may occur, especially if the temperature sensor device is heavily loaded by turbulence caused by the thermowell in the flow and thus vibrations induced on the thermowell. Such stresses can be decisively reduced by the support structure, as it can effectively absorb forces occurring at the thermowell and dampen or eliminate any vibrations that arise. This increases reliability and minimizes the risk of failure.

The first temperature sensor can be designed as a mineral-insulated sheathed cable. This means that the first temperature sensor has a thin-walled sensor sheath that includes mineral insulation. Within the mineral insulation, at least one sensor element is embedded. The sheath, for example, is made of stainless steel. Thus, each sensor element of the first temperature sensor is effectively protected from chemical and mechanical impairments caused by process media. At the same time, the first temperature sensor can be bent and can be aligned, relocated, moved to specific measuring points and attached there, for example, within a process chamber.

As already mentioned above, in such designs the support structure can effectively achieve that mechanical stresses caused by the bending or displacing of the first temperature sensor in the area of welding or soldering on the connector are significantly reduced or even eliminated, since the support structure prevents or severely restricts a deflection of the first temperature sensor and absorbs or intercepts the forces that occur. This increases reliability and minimizes the risk of failure.

The lateral gripping the first temperature sensor, at least in sections, can be carried out by the first support along a longitudinal support section. This longitudinal support section has a length that is greater than the diameter of the first temperature sensor, for example greater than twice the diameter of the first temperature sensor.

By creating a support section that extends longitudinally, mechanical stresses in the area where the first temperature sensor is welded or soldered (directly or indirectly) to the connector can be reduced even further. By contrast, in designs in which the first support only grips the first temperature sensor along a very short support section or only grips it at one point, the first support can act like a lever axis, so that the welding or soldering is not fully relieved of stress. By gripping along the extended longitudinal support section, such leverage can be prevented, or at least greatly reduced, so that the welding or soldering at the first through channel of the connector is effectively decoupled from mechanical forces and stresses acting on the first temperature sensor beyond the support structure.

The first temperature sensor can be limited in its deflection capability by the lateral grip by the first support, at least in sections, such that a cross-sectional center of the first temperature sensor at the first distance from the connector always rests at least essentially on an imaginary extension of an axis of the through channel.

The fact that the cross-sectional center “essentially” rests on the imaginary extension of the axis of the first through channel means that the first temperature sensor is limited in its deflection capability by the respective support in such a way that the cross-sectional center can be at any time no more than one diameter of the first temperature sensor away from this axis. For example, the first temperature sensor is even limited in its deflection capability in such a way that its cross-sectional center can be a maximum of 10 percent of its diameter away from this axis at any given time. In this context, a cross-section of the first temperature sensor is to be considered, which is perpendicular to a longitudinal extension of the first temperature sensor at the first distance from the connector.

This example encloses and holds the first temperature sensor by the support structure in such a deflection that the support structure itself causes no or only very low mechanical stresses in the area of the welding or soldering of the first temperature sensor at the first through channel. The first temperature sensor is therefore not prestressed or pre-bent by the support structure, or only very slightly. The temperature sensor device can therefore be designed particularly reliably and fail-safe. In addition, the temperature sensor device in this configuration is particularly easy to install, as the first temperature sensor can essentially be guided in a straight line through the first through channel to the first support.

The first support can have a first support plate with a first support channel. The lateral gripping of the first temperature sensor by the first support is due to the fact that the first temperature sensor is arranged to pass through the first support channel.

The support structure can be manufactured particularly easily and cost-effectively in this configuration and only a small number of components are required to set up the temperature sensor device.

The first support channel can be coaxial or concentric to the first through channel of the connector, for example. This makes it easier to assemble-specifically, threading or passing the first temperature sensor through- and the support structure exerts no or very little mechanical stress via the first temperature sensor on its weld or solder to the connector.

The first support channel can have a diameter that is 3 percent to 15 percent larger than the diameter of the first temperature sensor. Alternatively, the first support channel can have a clearance of 0.1 mm to 0.5 mm in radius as compared to a radius of the first temperature sensor. This means that the clearance is formed between a sheath surface of the first temperature sensor and a surface limiting a free opening of the first support channel. Such a configuration makes the temperature sensor device easy to install, as the first temperature sensor can be inserted smoothly into the first support channel. At the same time, these tolerances can effectively limit the deflection capability of the first temperature sensor.

The first support can include a clamping device. In this configuration, the lateral gripping of the first temperature sensor by the first support, at least in sections, is achieved by the fact that the first temperature sensor is detachably clamped or pressed against the first support by the clamping device or is clamped or clipped in place by the clamping device.

This example implements the feature of permanent contact between the first temperature sensor and the first support, which has already been discussed above, whereby a particularly effective limitation of the deflection capability of the first temperature sensor can be achieved. In addition, such a support structure can be installed particularly easily or even retrofitted to an existing temperature sensor device that previously did not include a support structure.

For this purpose, the first support may have, for example, a base support, which is centrally arranged, for example, wherein the first temperature sensor is guided laterally past the base support. After the base support is directly or indirectly mechanically rigidly connected to the connector, clamping jaws can be inserted laterally over the temperature sensor and screwed to the base support so that the temperature sensor is effectively enclosed laterally by the support, at least in sections.

The support structure can include a second support.

The second support—just like the first support—is or can be mechanically rigidly connected, directly or indirectly, to the connector. Furthermore, the second support encloses the first temperature sensor laterally at a second distance from the first support, at least in sections.

The explanations made in the context of the first support for the wording “laterally gripped in sections” and for the configuration of the limitation of the deflection capability of the first temperature sensor also apply mutatis mutandis to the second support.

In this configuration, mechanical stresses in the area of the (direct or indirect) welding or soldering of the first temperature sensor to the connector can be reduced even further. In configurations that only have the first support, the first support (as explained above) can act as a lever axis, so that the welding or soldering is not fully relieved of stress. This is particularly the case if the first support does not grip the first temperature sensor along a longitudinally extended support section, but only selectively or along a very short support section. The second support eliminates such leverage and allows for the welding or soldering to the first through channel of the connector to be effectively decoupled from mechanical forces and stresses acting on the first temperature sensor beyond the support structure.

For example, the second distance between the first and second supports can correspond to at least one diameter of the first temperature sensor, for example, at least two times the diameter. By means of an appropriate configuration, the effects and advantages of the support structure mentioned above can be achieved particularly effectively, while at the same time maintaining a compact design.

In an example of the temperature sensor device, which includes the second support, one of the supports may only be indirectly mechanically rigidly connected or connectable to the connector. This indirect connection is created by the fact that the respective support is directly or indirectly mechanically rigidly connected or connectable to another support, wherein the respective other support is directly or indirectly mechanically rigidly connected or connectable to the connector.

For example, the second support may be only indirectly mechanically rigidly connected or connectable to the connector, wherein this indirect connection is achieved by the fact that the second support is directly or indirectly mechanically rigidly connected or connectable to the first support. Similarly, the first support can be only indirectly mechanically rigidly connected or connectable to the connector, wherein this indirect connection in turn comes about because the first support is directly or indirectly mechanically rigidly connected or connectable to the second support.

This configuration allows for the first support and the second support to be pre-assembled together and then connected to the connector in a single step. This modularity can make the installation of the temperature sensor device much easier.

The first temperature sensor can be limited in its deflection capability by the lateral gripping by the second support, at least in sections, such that a cross-sectional center of the first temperature sensor at the second distance from the first support always rests at least essentially on an imaginary extension of an axis of the through channel.

The fact that the cross-sectional center is “essentially” on the imaginary extension of the axis of the first through channel applies mutatis mutandis, as has been explained above with respect to this wording.

Due to this configuration, the first temperature sensor is also gripped and held in such a deflection by the second support of the support structure, that no or only very low mechanical stresses are caused by the support structure itself in the area of the welding or soldering of the first temperature sensor at the first through channel. The first temperature sensor is therefore not prestressed or pre-bent by the support structure, or only very slightly. The temperature sensor device can therefore be designed particularly reliably and fail-safe. In addition, the temperature sensor device in this configuration can be mounted particularly easily, as the first temperature sensor can be guided to the second support, at least essentially in a straight line, through the first through channel.

The second support can have a second support plate with a second support channel. The lateral gripping of the first temperature sensor by the second support is achieved by the fact that the first temperature sensor is arranged to pass through the second support channel.

The support structure can be manufactured particularly easily and cost-effectively in this configuration and only a small number of components are required to set up the temperature sensor device.

The second support channel can be coaxial or concentric to the first through channel of the connector, for example. This makes it easier to assemble-specifically, threading or passing the first temperature sensor through- and the support structure exerts no or very little mechanical stress via the first temperature sensor on its welding or soldering to the connector.

The second support channel can have a diameter that is 3 percent to 15 percent larger than a diameter of the first temperature sensor. Alternatively, the second support channel can have a clearance of 0.1 mm to 0.5 mm in radius as compared to a radius of the first temperature sensor. This means that the clearance is formed between a sheath surface of the first temperature sensor and a surface limiting a free opening of the second support channel. Such a configuration makes the temperature sensor device easy to install, as at least one temperature sensor can be inserted smoothly into the second support channel. At the same time, these tolerances can effectively limit the deflection capability of the first temperature sensor.

The second support can comprise both the second support plate from the previous example and a connecting wall, which connects laterally to the second support plate, at least in sections. In this case, the second support plate can be mechanically rigidly connected or connectable, directly or indirectly, to the connector via the connecting wall. The first support is arranged between the connector and the second support plate and is laterally surrounded by the connecting wall, at least in sections. This configuration allows for the temperature sensor device to be particularly compact and stable and at the same time requires a very small number of components.

The second support can be in the shape of a pot, for example, so that the connecting wall is fully lateral to the second support plate. The second support is arranged in such a way that the inside of the pot shape, framed by the connecting wall, points in the direction of the connector. The first support is arranged within the pot shape, for example pushed into it, and can even include the first support plate described above.

In an example of the temperature sensor device, these include at least one other temperature sensor. At the same time, the connector has at least one additional through channel, so that exactly one of the other through channels is assigned to each additional temperature sensor. The number of additional through channels is therefore at least equal to the number of additional temperature sensors. Each additional temperature sensor is arranged to pass through the respective additional through channel assigned to it and welded or soldered directly or indirectly into the respective additional through channel assigned to it, at least on the process side. The first support encloses each additional temperature sensor laterally at the first distance from the connector, at least in sections, as does the first temperature sensor.

This configuration thus indicates that the temperature sensor device comprises at least two temperature sensors (the first and at least one other temperature sensor) instead of only a single temperature sensor (the first temperature sensor), wherein all temperature sensors are laterally enclosed by the support structure, at least in sections. This allows for multiple temperature sensors to be used with a single such temperature sensor device via a single process connection, making the temperature sensor device more versatile. At the same time, the benefits that can be achieved through the support structure can be effectively applied to any temperature sensor.

Each additional temperature sensor as well as the first temperature sensor can be configured this way, for example, as a mineral-insulated sensor sheathed cable.

In general, this example can be advantageously combined with all the examples mentioned above. What has been explained in each example with regard to the first temperature sensor can be transferred accordingly to each of the other temperature sensors.

The disclosure content of this document is not limited to the features of the above-mentioned examples and/or further developments, but also includes any combination of these features, insofar as they are not logically mutually exclusive.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIGS. 1A-1C show various exemplary temperature sensor devices in accordance with the state of the art schematically in cross-section;

FIGS. 2A-2D show various examples of a temperature sensor device schematically in cross-section;

FIGS. 3A-3C show various examples of a temperature sensor device schematically in cross-section;

FIG. 4 shows an example of a temperature sensor device in a perspective representation;

FIG. 5 shows an example of a temperature sensor device in a perspective representation;

FIG. 6 shows the example from FIG. 2A in the cross-section VI drawn in it; and

FIG. 7 shows an example of a temperature sensor schematically in cross-section.

### DETAILED DESCRIPTION

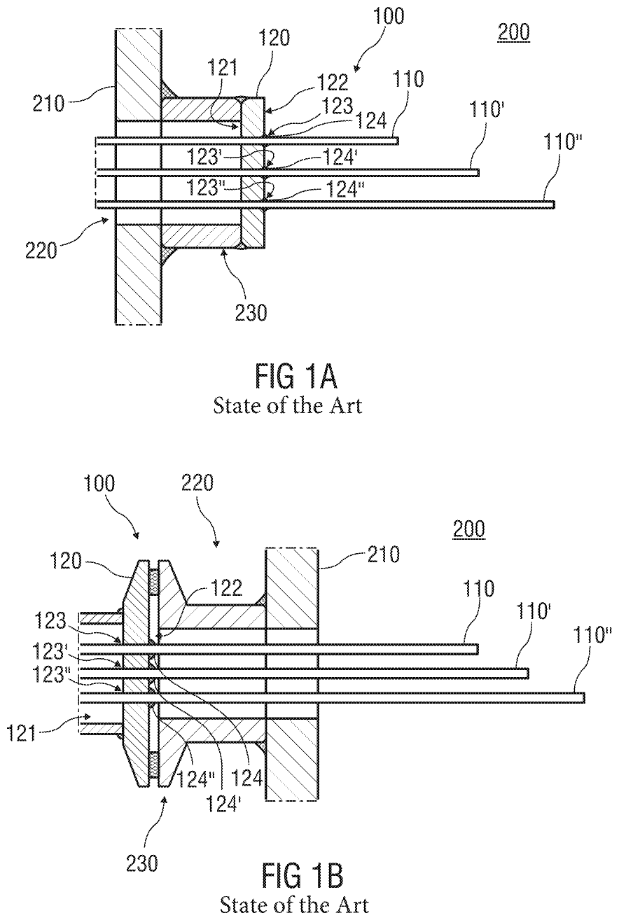

In FIGS. 1A to 1C, three different examples of temperature sensor devices 100 are shown schematically in a cross-section in accordance with the state of the art.

In all three FIGS. 1A-1C, the respective temperature sensor device 100 is shown connected to a process connection 230, to a measuring point 220 to a process chamber or to process piping 200. Of the respective process chamber or process piping 200, only one wall 210 is shown in sections, wherein in the FIGS. 1A-1C there is an interior of the respective process chamber or process piping 200 to the right of the wall 210, in which a temperature measurement is to be carried out by the temperature sensor device 100.

FIGS. 1A and 1B show examples that comprise a total of three temperature sensors 110, 110′, 110″, namely a first temperature sensor 110 each and two further temperature sensors 110′, 110″. These are designed as mineral-insulated sheathed sensor cables. FIG. 1C, on the other hand, shows an example with a single temperature sensor 110, which has a thermowell 111. Inside the thermowell 111 is a measuring insert 112.

In all three FIGS. 1A-1C, the respective process connection 230 is closed by a connector 120, so that a medium from the inside of the process chamber or process piping 200 cannot escape through the process connection 230. In FIGS. 1B and 1C, the process connection 230 each comprises a neck tube, at the end of which a flange geometry is provided. In these examples, the connector 120 is designed accordingly in the form of a corresponding flange. In FIG. 1A, on the other hand, the process connection 230 comprises a welding nozzle protruding into the interior of the process chamber or process piping 200, to which the connector 120 is welded. The connector 120 is designed in the form of a plate or disc.

The connectors 120 from FIGS. 1A and 1B each have a total of three through channels 123, 123′, 123″, namely a first through channel 123 each, as well as two further through channels 123′, 123″. The connector 120 from FIG. 1C, on the other hand, has only a first through channel 123. The respective temperature sensors 110, 110′, 110″ are each pushed through one of the through channels 123. 123′. 123″ in all three FIGS. 1A-1C from an input side 121 of the connector 120 to a process side 122, so that they protrude into the process chamber or process piping 200. On the respective process side 122 of the connectors 120, the temperature sensors 110, 110′, 110″ are each connected to the respective connector 120 by welded connections or soldered connections 124, 124′, 124″, wherein the connector 120 is sealed.

Mechanical forces exerted, for example, by a medium flowing in a process piping 200 on at least one of the temperature sensors 110, 110′, 110″, or which are generated, for example, by at least one temperature sensor 110, 110′, 110″ being bent within the process chamber or process piping 200 in order to be guided to a specific measuring point, can cause mechanical stresses at the location of these welded or soldered connections 124, 124′, 124″. These can be damaged as a result, causing the connector 120 to leak and a medium to escape from the inside of the process chamber or process piping 200 through one of the through channels 123, 123′, 123″.

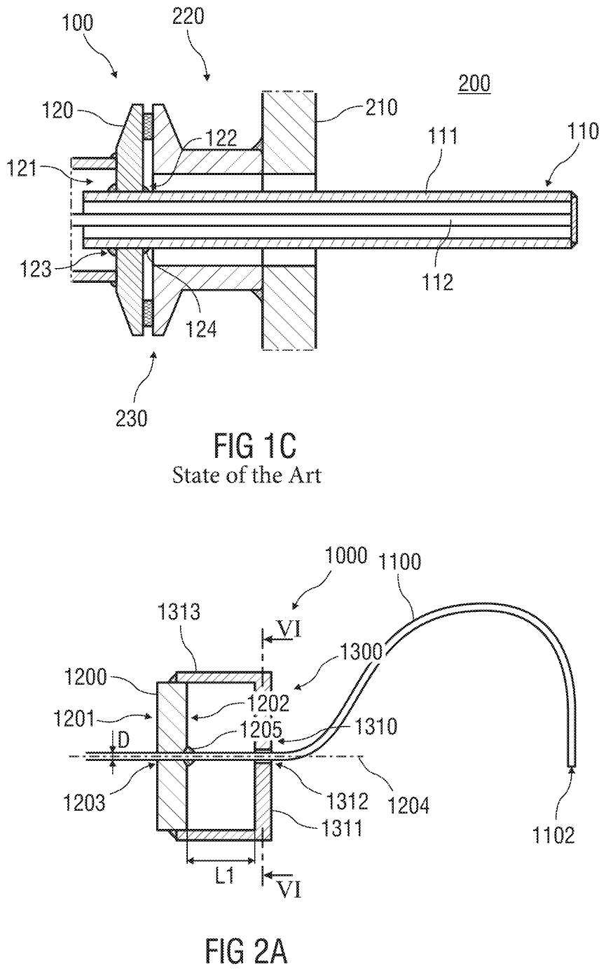

The present invention addresses this problem by providing a support structure 1300 which supports at least one temperature sensor 1100, 1100′, 1100″, absorbs forces and thus decouples welded or soldered connections 1205, 1205′ 1205″ from mechanical stresses or at least drastically reduces them. Examples of a temperature sensor device 1000 according to the invention are shown in FIGS. 2A-2D, 3A-3C and 4-7.

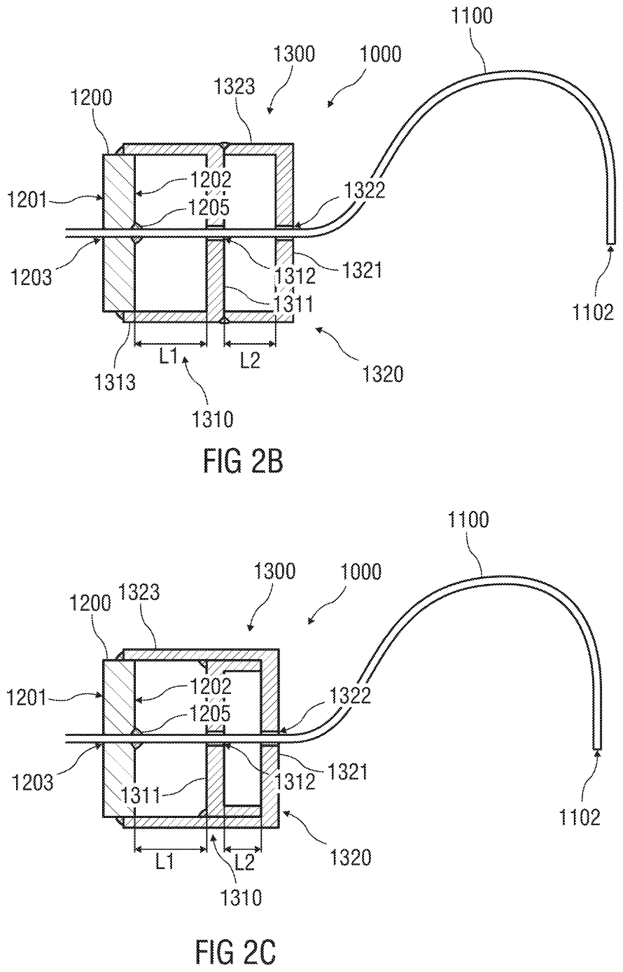

FIGS. 2A-2D and 3A-3C represent examples of a temperature sensor device 1000 with a support structure 1300. Each of the examples includes a connector 1200, which is similar to the variant of the connector 1200 from FIG. 1A. However, alternative designs of the connector 1200, similar to the connectors 1200 from FIGS. 1B and 1C, are also possible.

At least one first temperature sensor 1100 is guided from an input side 1201 through a first through channel 1203 to a process side 1202 of the respective connector 1200, so that a distal end 1102 of the temperature sensor 1100 protrudes beyond the level of the process side 1202 and the temperature sensor 1100 can penetrate a process chamber or process piping if the connector 1200 is connected to a corresponding process connection. The first temperature sensor 1100 is connected in each case to the edge of the first through channel 1203 by a welded or soldered connection 1205 on the process side 1202 of the connector 1200 in a sealed manner, in other words welded or soldered in.

While the FIGS. 2A-2D each comprise only a single temperature sensor 1100, the examples in FIGS. 3A-3C each have a total of three temperature sensors 1100, 1100′, 1100″, namely the first temperature sensor 1100 and two further temperature sensors each 1100′, 1100″. Analogous to the first temperature sensor 1100′, the other temperature sensors 1100′, 1100″ are each guided from the input side 1201 through further through channels 1203′, 1203″ to the process side 1202 of the respective connector 1200, so that distal ends 1102′, 1102″of the other temperature sensors 1100′, 1100″ protrude beyond the level of the process side 1202 and they can penetrate a process chamber or process piping, when the connector 1200 is connected to a corresponding process connection. The other temperature sensors 1100′, 1100″ are also each connected by welded or soldered connections 1205′, 1205″ on the process side 1202 of the connector 1200 all around the edge of the further through channel 1203′, 1203″ assigned to them, in other words welded in or soldered in.

FIGS. 2A, 2D and 3A have in common that the support structure 1300 shown in each case has a first support 1310, which comprises a first support plate 1311, which is spaced by a first distance L1 from the connector 1200. The first support plate 1311 provides a number of first support channels 1312, 1312′, 1312″, which corresponds to the number of temperature sensors 1100, 1100′, 1100″ present in the respective example.

The diameter of the first support channels 1312, 1312′, 1312″ is such that the temperature sensors 1100, 1100′, 1100″ can be pushed through them smoothly, but at the same time they effectively limit the deflection capability of the temperature sensors 1100, 1100′, 1100″ in all lateral directions.

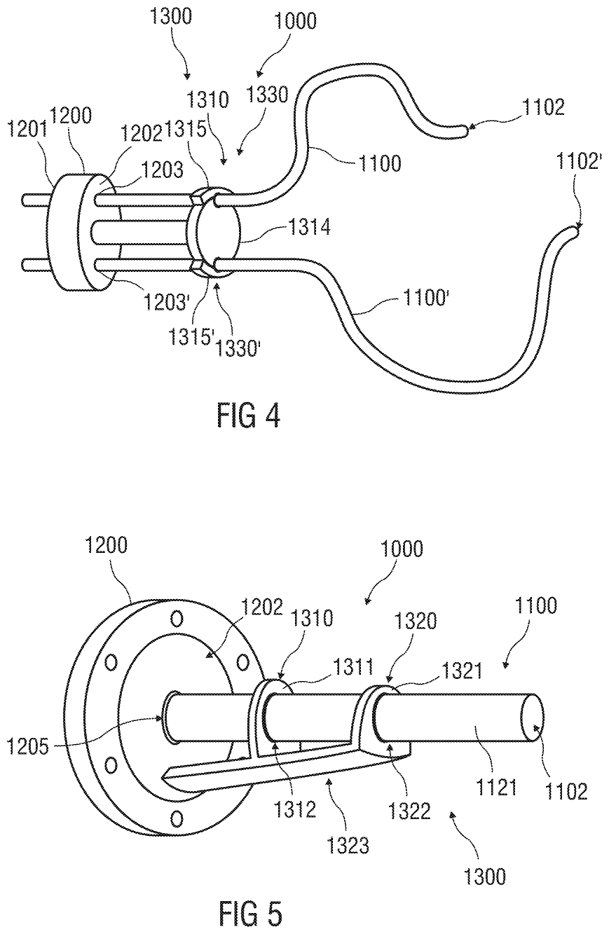

As can be seen in FIG. 6, which represents the cross-section through the level VI drawn in FIG. 2A, this can be achieved by the fact that the first support channel 1312 has a clearance S in the radius as compared to the radius of the first temperature sensor 1100. This means that the clearance S is formed between a sheath surface of the first temperature sensor 1100 and a surface surrounding a free opening of the first support channel 1312. For example, this clearance S can be 0.1 mm to 0.5 mm, or a diameter of the first support channel 1312 is 3 to 15 percent larger than a diameter D of the first temperature sensor 1100. The same applies for the additional first support channels 1312′, 1312″.

In an example of the temperature sensor device 1000, the first temperature sensor 1100 is held in the first support channel 1312, or is laterally gripped by the first support 1310, at least in sections, in such a way that the deflection capability of the first temperature sensor 1100 is limited such that the cross-sectional center of the first temperature sensor 1100 rests at least substantially on the imaginary extension of the axis 1202 of the first through channel 1203. This means that the deflection capability of the first temperature sensor 1100 is restricted by the respective support 1310 such that the cross-sectional center can at any time be located at a maximum distance of the diameter D of the first temperature sensor 1100 from this axis 1204. This is illustrated in FIG. 6 by the dashed line. For example, the deflection capability of the first temperature sensor 1100 is restricted to such an extent that its cross-sectional center can at any time be a maximum of 10 percent of its diameter D away from this axis 1204. In this context, a cross-section through the first temperature sensor 1100 must be considered, which rests at the first distance L1 from the connector 1200 perpendicular to a longitudinal extension of the first temperature sensor 1100.

Furthermore, the first support channels 1312, 1312′, 1312″ are positioned in such a way that they essentially rest on an imaginary extension of an axis 1204 (see FIG. 6 and as an example also FIG. 2A; the drawing of corresponding axes has been omitted in FIGS. 2B-2D and 3A-3C for the sake of clarity) through the respective assigned through channel 1203, 1203′, 1203″. In particular, related through channels 1203, 1203′, 1203″ and first support channels 1312, 1312′, 1312″ are each arranged coaxially or concentrically. As a result, the first support 1310 can be easily slid onto the temperature sensors 1100, 1100′, 1100″ and does not cause mechanical stresses on the welded or soldered connections 1205, 1205′, 1205″, since the temperature sensors 1100, 1100′, 1100″ run straight from the connector 1200 through the support structure 1300 and are not bent.

The first support plate 1311 is connected or can be connected to the connector 1200 by a first connecting wall 1313. In FIGS. 2A, 2D and 3A, this connection is shown directly in each case, since the first connecting wall 1313 is welded directly to the connector 1200. An indirect connection would also be possible. In this case, the first connecting wall 1313 can be connected to the first support plate 1311 fully laterally, so that the first support 1310 forms a pot shape. This allows for a particularly high mechanical stability to be achieved.

The example shown in FIG. 2D differs from that in FIG. 2A in that the first support plate 1311 has a greater thickness. This results in the first temperature sensor 1100 being laterally gripped, enclosed, or surrounded by the first support 1300, at least in sections, along a longitudinal support section 1316, which is longer than that shown in FIG. 2A. In the example from FIG. 2D, the length LS of the longitudinal support section 1316 corresponds at least to the diameter D of the first temperature sensor 1100, and for example, at least twice the diameter D. By using such a longitudinally extended support section 1316, the welded or soldered connection 1205 can be particularly effectively decoupled from mechanical loads, as leverage on the first support 1310 is effectively prevented or at least drastically reduced. This is particularly helpful in configurations where the support structure 1300 comprises only the first support 1310 and thus does not include a second support 1320.

For the sake of clarity, the reference signs 1316 and LS have been omitted in FIGS. 2A-2C, 3A-3C, 4, and 5. However, corresponding support sections and lengths can obviously be identified for each of the illustrated example.

FIGS. 2B, 3B, 2C and 3C have in common that the support structure 1300 shown in each case has a second support 1320 in addition to a first support 1310. The respective second support 1320 comprises a second support plate 1321, which is spaced by a second distance L2 from the respective first support 1310. In the respective second support plate 1321, a number of second support channels 1322, 1322′, 1322″ is provided, which corresponds to the number of temperature sensors 1100, 1100′, 1100″ present in the respective example.

The respective second support channels 1322, 1322′, 1322″ are each arranged in such a way that they at least essentially rest on an imaginary extension of an axis 1204 (see FIG. 6) through the respective assigned through channel 1203, 1203′, 1203″. In particular, related through channels 1203, 1203′, 1203″ and second support channels 1322, 1322′, 1322″ are each arranged coaxially or concentrically. As a result, the second support 1320 can be easily slid onto the temperature sensors 1100, 1100′, 1100″ and does not cause mechanical stresses on the welded or soldered connections 1205, 1205′, 1205″, since the temperature sensors 1100, 1100′, 1100″ run straight from the connector 1200 through the support structure 1300 and are not bent.

With regard to the diameters of the second support channels 1322, 1322′, 1322″, what has been explained above in the context of the first through channels 1312, 1312′, 1312″ applies accordingly.

The second support 1320 has a second connecting wall 1323. In FIGS. 2B and 3B, the respective second support 1320 is connected to the first support 1310 by its connecting wall 1323, which in turn is connected to the connector 1200. Thus, the second support 1320 in each of these figures is only indirectly connected to the connector 1200. In FIGS. 2C and 3C, on the other hand, the second support 1320 is directly connected to the connector 1200 via the respective second connecting wall 1323, while the first support 1310 is arranged between them and is only indirectly connected to the connector 1200 via the second support 1320.

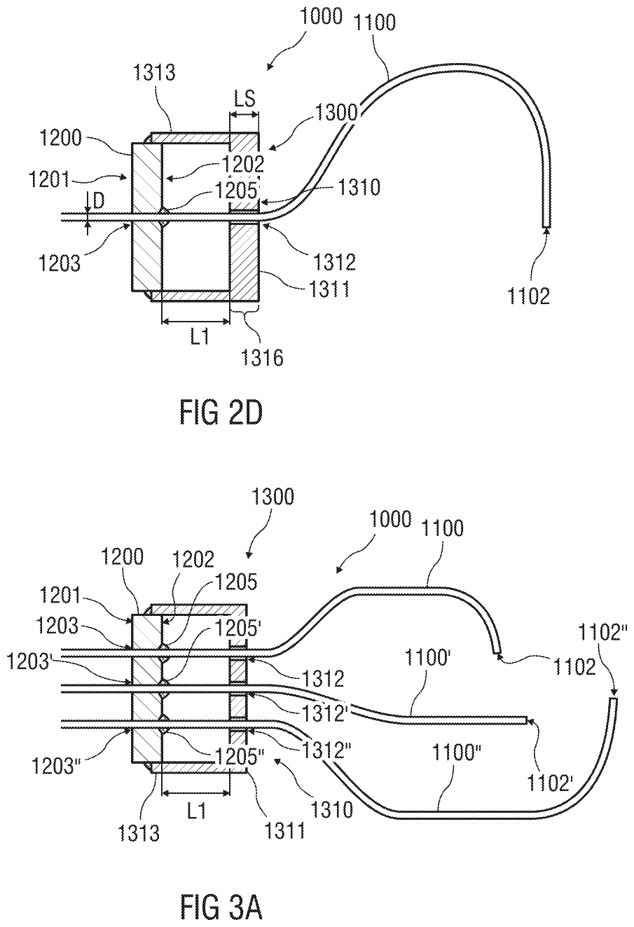

FIG. 4 shows an example of the temperature sensor device 1000 in a perspective view. In this example, the temperature sensor device 1000 includes a first temperature sensor 1100 and another temperature sensor 1100′. The support structure 1300 here includes two clamping devices 1330, 1330′ to clamp both temperature sensors 1100, 1100′ against the support structure 1300. For this purpose, the support structure 1300 has a base support 1314, as well as two clamping jaws 1315, 1315′, which can be screwed against the base support 1314 and clamp a temperature sensor 1100, 1100′ each.

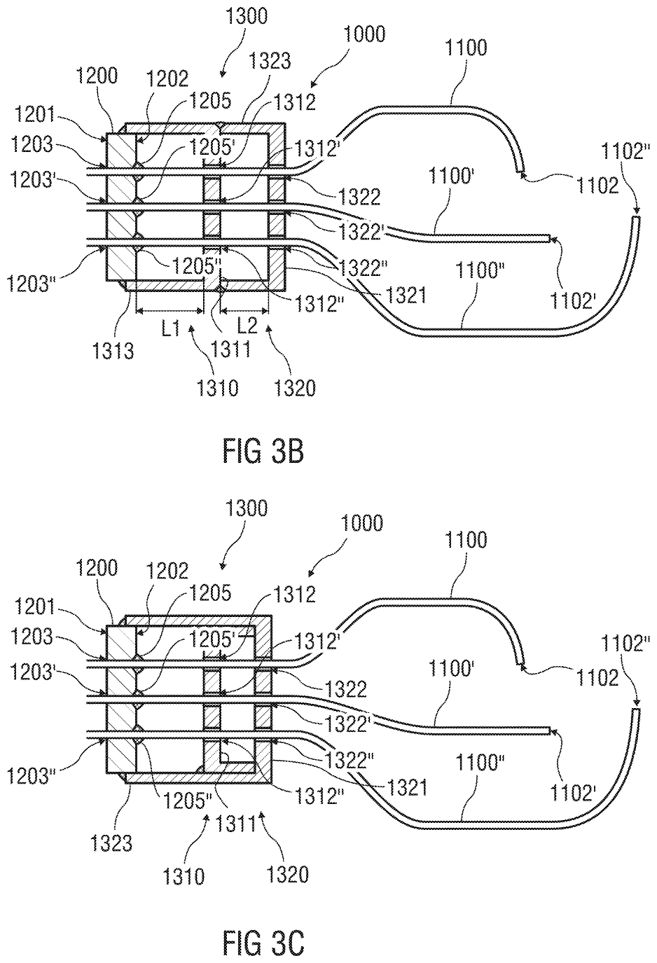

FIG. 5 shows an example of the temperature sensor device 1000 in a perspective view. The first temperature sensor 1100 comprises a thermowell 1121, i.e., it is similar in design to the temperature sensor device 100 from FIG. 1C, which is known from the state of the art.

In this example, the support structure 1300 comprises a first support 1310 and a second support 1320, each of which has a first support plate 1311 with a first support channel 1312, or a second support plate 1321 with a second support channel 1322. A connecting wall 1323 connects both support plates 1311, 1321 mechanically rigidly with the connector 1200. As a result, the support structure 1300 is able to effectively absorb or dampen mechanical loads, such as forces or vibrations acting on the side of the thermowell 1121, so that mechanical stresses and loads on the welded or soldered connection 1205 are reduced or even completely prevented.

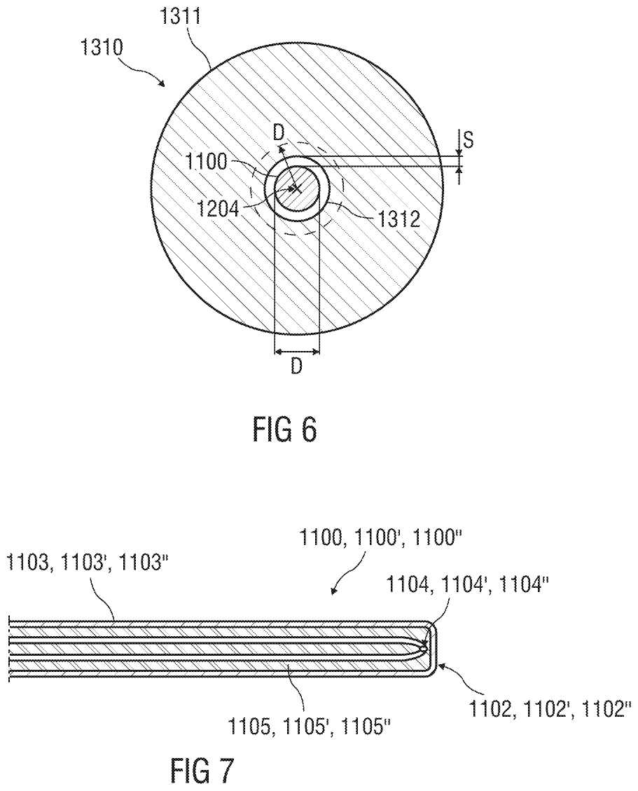

The first temperature sensors 1100 and/or further temperature sensors 1100′, 1100″ shown in FIGS. 2A-2D, 3A-3C, 4 and 6 can, in examples, be embodied as mineral-insulated sheathed sensor cables. An example is shown schematically in cross-section in FIG. 7. A thin-walled metallic sheath 1103, 1103′, 1103″ encloses mineral insulation 1105, 1105′, 1105″. One or more sensor elements 1104, 1104′, 1104″ are arranged within the insulation 1105, 1105′, 1105″.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

1. A temperature sensor device comprising:
a first temperature sensor with at least one temperature-sensitive sensor element;
a connector having an input side and a process side opposite the input side;
a first through channel extending from the input side to the process side, the first temperature sensor being arranged to pass through the first through channel and is welded or soldered directly or indirectly into the first through channel, at least on the process side; and
a support structure that is directly or indirectly mechanically rigidly connected or connectable to the connector and has a first support that laterally grips, encloses or surrounds the first temperature sensor at a first distance from the connector, at least in sections.

2. The temperature sensor device according to claim 1, wherein the first temperature sensor is a mineral-insulated sheathed sensor cable, or wherein the first temperature sensor comprises a thermowell with a measuring insert.

3. The temperature sensor device according to claim 1, wherein the first distance is at least three times the diameter of the first temperature sensor or at least four times the diameter of the first temperature sensor.

4. The temperature sensor device according to claim 1, wherein the lateral gripping, enclosing or surrounding of the first temperature sensor at least in sections is effected by the first support along a longitudinal support section, and wherein the longitudinal support section has a length that is greater than a diameter of the first temperature sensor or is greater than twice the diameter of the first temperature sensor.

5. The temperature sensor device according to claim 1, wherein the first temperature sensor is limited in its deflection capability by the lateral gripping, enclosing or surrounding by the first support, at least in sections, such that a cross-sectional center of the first temperature sensor at the first distance from the connector always at least essentially rests on an imaginary extension of an axis of the first through channel.

6. The temperature sensor device according to claim 1, wherein the first support has a first support plate with a first support channel, and wherein the first temperature sensor is guided through the first support channel.

7. The temperature sensor device according to claim 6, wherein the first support channel has a diameter which is 3 percent to 15 percent larger than a diameter of the first temperature sensor and/or wherein the support channel has a clearance of 0.1 mm to 0.5 mm in radius as compared to a radius of the first temperature sensor.

8. The temperature sensor device according to claim 1, wherein the first support comprises a clamping device, wherein the first temperature sensor is laterally gripped, enclosed or surrounded by the first support, at least in sections, in that the first temperature sensor is detachably clamped or pressed against the first support by the clamping device or is clamped or clipped by the clamping device.

9. The temperature sensor device according to claim 1, further comprising at least one additional temperature sensor,
wherein the connector has at least one further through channel,
wherein exactly one of the further through channels is assigned to each additional temperature sensor so that the number of additional through channels is at least equal to the number of additional temperature sensors,
wherein each additional temperature sensor is arranged such that it passes through its respective assigned further through channel and is welded or soldered, at least on the process side, directly or indirectly, into the respective further through channel assigned to it, and
wherein the first support laterally grips, encloses or surrounds each additional temperature sensor at a first distance from the connector, at least in sections.

10. The temperature sensor device according to claim 9, wherein each additional temperature sensor is designed as a mineral-insulated sheathed sensor cable.

11. The temperature sensor device according to claim 1, wherein the support structure comprises a second support that is directly or indirectly mechanically rigidly connected or connectable to the connector and that laterally grips, encloses or surrounds the first temperature sensor at a second distance from the first support, at least in sections.

12. The temperature sensor device according to claim 11, wherein the second distance corresponds to at least one diameter of the first temperature sensor or corresponds at least to twice the diameter of the first temperature sensor.

13. The temperature sensor device according to claim 11, wherein the second support is only indirectly mechanically rigidly connected or connectable to the connector, wherein this indirect connection is achieved in that the second support is directly or indirectly mechanically rigidly connected or connectable to the first support, or wherein the first support is only indirectly rigidly mechanically connected or connectable to the connector, this indirect connection being achieved in that the first support is directly or indirectly mechanically rigidly connected or connectable to the second support.

14. The temperature sensor device according to claim 11, wherein the first temperature sensor is limited in its deflection capability by the lateral gripping, enclosing or surrounding by the second support, at least in sections, such that a cross-sectional center of the first temperature sensor at the second distance from the first support always at least essentially rests on an imaginary extension of an axis of the first through channel.

15. The temperature sensor device according to claim 11, wherein the second support comprises a second support plate with a second support channel, wherein the first temperature sensor is guided through the second support channel.

16. The temperature sensor device according to claim 15, wherein the second support channel has a diameter which is 3 percent to 15 percent larger than a diameter of the first temperature sensor and/or wherein the second support channel has a clearance of 0.1 mm to 0.5

17. The temperature sensor device according to claim 15, wherein the second support has a connecting wall that connects laterally to the second support plate, at least in sections, wherein the second support plate is mechanically rigidly connectable or connected to the connector directly or indirectly via the connecting wall, and wherein the first support is arranged between the connector and the second support plate and is laterally surrounded by the connecting wall, at least in sections.

18. The temperature sensor device according to claim 11, further comprising at least one further temperature sensor, wherein the connector has at least one further through channel, wherein each additional temperature sensor is assigned to exactly one of the other through channel so that the number of additional through channels is at least equal to the number of additional temperature sensors, wherein each additional temperature sensor is guided through the respective further through channel assigned to it and is welded or soldered, at least on the process side, directly or indirectly, into the respective further through channel assigned to it, wherein the first support laterally grips, encloses or surrounds each additional temperature sensor at the first distance from the connector, at least in sections, and wherein the second support laterally grips, encloses or surrounds each additional temperature sensor at the second distance from the first support, at least in sections.

19. Temperature sensor device according to claim 18, wherein each additional temperature sensor is designed as a mineral-insulated sheathed sensor cable.
